(19) United States
(12) Patent Application Publication
(10) Pub. No.: US 2007/0145899 A1
(43) Pub. Date: Jun. 28, 2007

(54) MAGNETRON

(75) Inventors: Seung-Won BAEK, Seoul (KR); Jong-Soo LEE, Anyang (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/615,405

(22) Filed: Dec. 22, 2006

(30) Foreign Application Priority Data
Dec. 27, 2005 (KR) 10-2005-0131014

(51) Int. Cl. H01J 25/50

(52) U.S. Cl. 315/39.51

(57) ABSTRACT

A magnetron is provided including a yoke having an inner space; a first magnet provided at one end of the inner space, a second magnet provided at a second end of the inner space, the second magnet being axially spaced from the first magnet. Further, there is an anode cylinder that generates a high frequency provided between the first magnet and the second magnet; a first pole piece and a second pole piece provided proximate first and second openings of the anode cylinder, respectively. Additionally, a seal that prevents outward leakage and has an inward protrusion extending axially toward the anode cylinder; and a choke filter, provided beneath a free end of the inwardly bent end of the seal to prevent outward leakage, may be provided.

### RELATED APPLICATION

The present disclosure relates to subject matter contained in priority Korean Application No. 10-2005-0131014, filed on Dec. 27, 2005, which is herein expressly incorporated by reference in its entirety.

### BACKGROUND OF THE INVENTION

1. Field of the Invention

The present invention relates to a magnetron, and more particularly, to a magnetron capable of preventing a third harmonic and a fifth harmonic generated therefrom from being outwardly leaked, and capable of preventing a high side band and a low side band of the third harmonic and the fifth harmonic.

2. Description of the Background Art

FIG. 1 is a perspective view showing a magnetron in accordance with the conventional art, FIG. 2 is a sectional view taken along the line ‘II-II’ in FIG. 1, FIG. 3 is a perspective view showing a choke filter of FIG. 1, and FIG. 4 is a graph showing a noise level at a third harmonic band and a fifth harmonic band in a microwave oven to which the conventional magnetron is applied.

As shown, the conventional magnetron comprises a yoke 301 having an inner space formed by an upper yoke 301a and a lower yoke 301bcoupled together; an upper magnet 321 and a lower magnet 322 received in the inner space, and fixed to inner surfaces of the upper yoke 301a and the lower yoke 301b, respectively; an anode cylinder 302 disposed between the upper magnet 321 and the lower magnet 322 for generating energy of a high frequency; an upper pole piece 313 and a lower pole piece 314 having a funnel shape, and disposed at upper and lower openings of the anode cylinder 302, respectively; a cylindrical A-seal 315 disposed at an upper side of the upper pole piece 313 for preventing a fifth harmonic from being outwardly leaked; and a coaxial choke filter 330 adhered to an inner surface of the A-seal for preventing a third harmonic from being outwardly leaked. As the upper yoke 301a and the lower yoke 301b are coupled to each other, the yoke 301 has a side section of a square shape. The anode cylinder 302 is disposed in the yoke 301, and a plurality of vanes 303 serving as a resonator for outputting a high frequency are radially disposed in the anode cylinder 302 in a shaft direction.

An inner pressure-equalizing ring 304 and an outer pressure-equalizing ring 305 are alternately coupled to upper and lower portions of the end of the vane 303, thereby constituting an anode together with the anode cylinder 302.

A filament 307 is spirally wound on a shaft of the anode cylinder 302 so as to form a space 306 having a certain gap from an end of the vane 303. The filament 307 is formed of a mixture material of tungsten and thorium oxide, and constitutes a cathode for emitting thermo-electron by being heated a current supplied to the filament 307.

A top sealed 308 for preventing thermo-electron from the filament from being upwardly emitted is disposed at an upper end of the filament 307, and an end sealed 309 for preventing thermo-electron from the filament from being downwardly emitted is disposed at a lower end of the filament 307. A center lead 310 formed of molybdenum is inserted into a through hole formed at the center of the end sealed 309, thereby being fixed to a lower surface of the top sealed 308. An upper end of a side lead 311 formed of molybdenum and spaced from the center lead 310 with a certain distance is fixed to a lower surface of the end sealed 309.

An upper pole piece 313 and a lower pole piece 314 formed of a magnetic substance and having a funnel shape are coupled to upper and lower openings of the anode cylinder 302, respectively. A cylindrical A-seal 315 and a cylindrical F-seal 316 for preventing an outward leakage of a third harmonic are respectively bonded to an upper side of the upper pole piece 313 and a lower side of the lower pole piece 314 by a brazing method.

A bending portion 315a for preventing an outward leakage of a fifth harmonic by forming a closed circuit by being bending towards inside of the A-seal 315 and downwardly extending from the A-seal 315 in a height direction is formed at an upper end of the A-seal 315.

A coaxial choke filter 330 coaxially extending from the bending portion 315a in a height direction of the magnetron is disposed at a lower side of the A-seal 315. The choke filter 330 includes a cylinder portion 331 having a diameter smaller than an inner circumference of the A-seal 315, and extending from the A-seal 315 in a height direction; a bonding portion 332 extending from an upper end of the cylinder portion 331 in a diameter direction of the cylinder portion 331 so that the cylinder portion 331 can be bonded to an inner circumference of the A-seal 315; and a through hole 333 penetratingly formed at the center of the cylinder portion 331.

An A-ceramic 317 for outwardly outputting a high frequency and an F-ceramic 318 are respectively bonded to an upper side of the A-seal 315 and a lower side of the F-seal 316 by a brazing method using heat. An exhaust pipe 319 is bonded to an upper side of the A-ceramic 317 by a brazing method. The exhaust pipe 319 is bonded to an upper end of the A-ceramic 317 so as to maintain inside of the anode cylinder 302 as a vacuum state.

An antenna 320 for outputting a high frequency oscillated in the resonator is installed in the A-seal 315. A vane 303 is connected to a lower end of the antenna 320, and an upper end of the antenna 320 is fixed to an inner upper surface of the exhaust pipe 319.

The upper magnet 321 and the lower magnet 322 are respectively coupled to an upper side and a lower side of the anode cylinder 302 so as to come in contact with an inner surface of the yoke 301, thereby forming a magnetic field together with the upper pole piece 313 and the lower pole piece 314.

A cooling fin 323 is disposed between an inner circumferential surface of the yoke 301 and an outer circumferential surface of the anode cylinder 302. Also, an antenna cap 324 for protecting a bonding portion of the exhaust pipe 319 is disposed at an upper side of the A-ceramic 317.

As an external power is supplied to the center lead 310 and the side lead 311, a closed circuit of the center lead 310, the filament 307, the top-sealed 308, the end sealed 309, and the side lead 311 is constructed. Accordingly, a current is supplied to the filament 307 thus to heat the filament 307. As the filament 307 is heated, thermo-electron is emitted therefrom and thereby an electron group is formed.

A strong electric field is generated in the space by a driving voltage supplied to the anode through the side lead 311. As a magnetic flux generated by the upper magnet 321 and the lower magnet 322 is applied to the space along the lower pole piece 314 towards the upper pole piece 313, a strong magnetic field is generated in the space. Thermo-electron emitted into the space 306 from a surface of the filament 307 of a high temperature receives force in a vertical direction by the strong electric field inside the space 306. Then, the thermo-electron is spirally moved thus to reach the vane 303.

The electron group formed by the electron motion causes an interference to the vane 303 with a period corresponding to 1/αn. Herein, the α denotes an oscillation period of a high frequency, and n denotes a multiple. Accordingly, an inductance formed by the space between the vanes 303 and the anode cylinder 302 constitutes a parallel resonance circuit, and a high frequency is applied to an antenna 320 from the vane 303. Then, the high frequency is emitted outside the magnetron 300 through the antenna 320, thereby driving an electronic device such as a plasma lighting system or a microwave oven.

However, the conventional microwave oven having a magnetron has the following problems. Referring to the graph of FIG. 3, a noise level has a great variation width at a third harmonic band and a fifth harmonic band. The third harmonic frequency and the fifth harmonic frequency are leaked outside the magnetron, which may result in harm to a human's body or on may badly influence a peripheral device, e.g., such as a television receiver or a radio.

### SUMMARY OF THE INVENTION

Therefore, an object of the present invention is to provide a magnetron capable of preventing a third harmonic and a fifth harmonic generated therefrom from being outwardly leaked, and capable of preventing a high side band and a low side band of the third harmonic and the fifth harmonic.

To achieve these and other advantages and in accordance with the purpose of the present invention, as embodied and broadly described herein, there is provided a magnetron, including a yoke having an inner space which may be formed by an upper (or first) yoke and a lower (or second) yoke coupled to each other; an upper (or first) magnet and a lower (or second) magnet received (or provided) in the inner space, and fixed to inner surfaces of the upper yoke and the lower yoke in a width direction of the yoke, respectively; an anode cylinder disposed between the upper magnet and the lower magnet for generating a high frequency; an upper (or first) pole piece and a lower (or second) pole piece having a funnel shape, and disposed at upper (or first) and lower (or second) openings of the anode cylinder, respectively; a cylindrical A-seal disposed at an upper side (or an upper end) of the upper pole piece, and having a bending portion inwardly bent from an upper end of the A-seal and downwardly extending (i.e., in an axial direction toward a choke filter), for preventing a fifth harmonic from being outwardly leaked; and a vertical choke filter disposed at a lower side (or beneath a free end of the bending portion) of the A-seal in a height direction for preventing a third harmonic from being outwardly leaked.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention is further described in the detail description which follows, in reference to the noted plurality of drawings, by way of non-limiting examples of preferred embodiments of the present invention, in which like characters represent like elements throughout the several views of the drawings, and wherein:

FIG. 1 is a perspective view showing a magnetron in accordance with the conventional art;

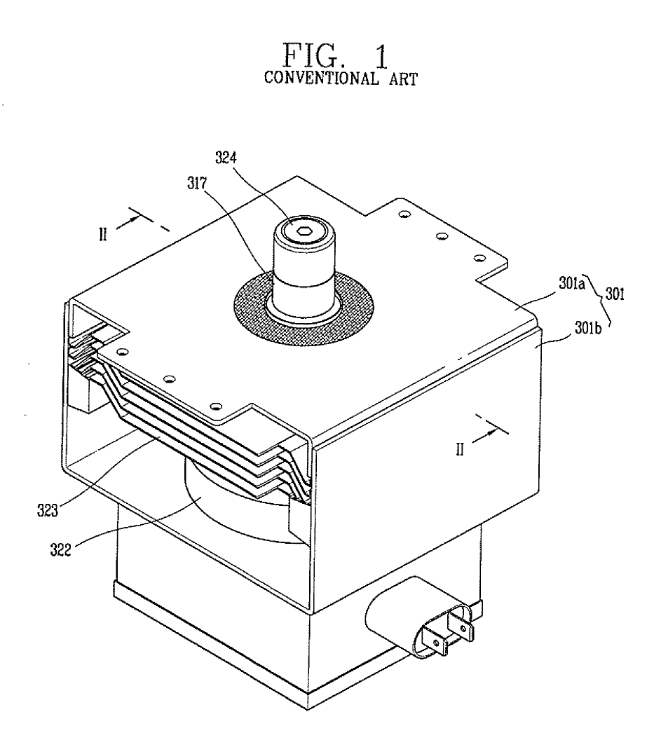

FIG. 2 is a sectional view taken along the line ‘II-II’ in FIG. 1;

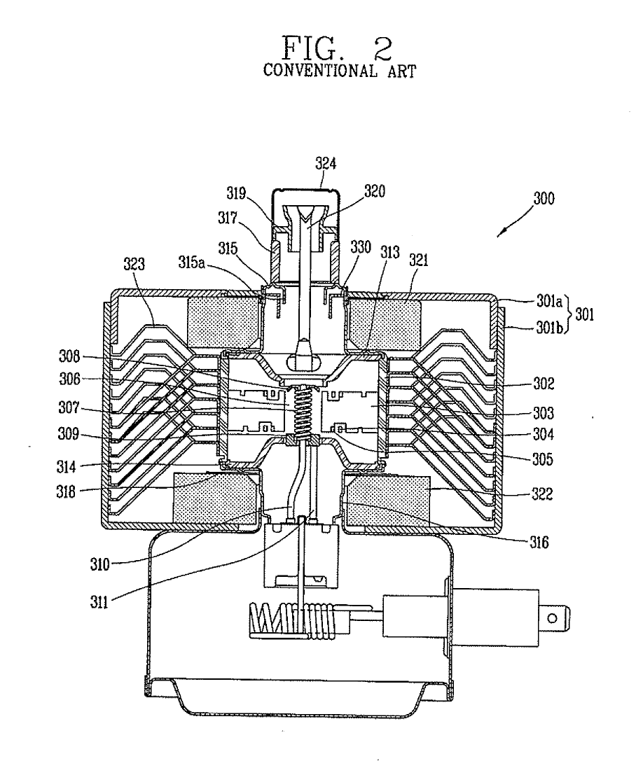

FIG. 3 is a perspective view showing a choke filter of FIG. 1; and

FIG. 4 is a graph showing a noise level at a third harmonic band and a fifth harmonic band in a microwave oven to which the conventional magnetron is applied;

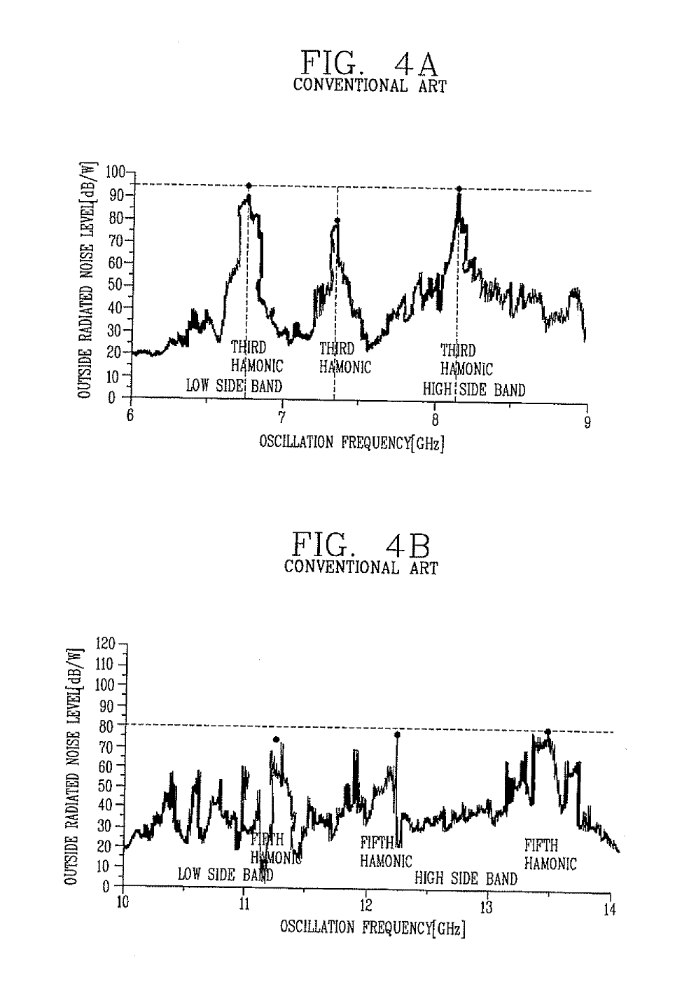

FIG. 5 is a side sectional view showing a magnetron according to a first embodiment of the present invention;

FIG. 6 is a perspective view showing the choke filter of FIG. 3;

FIG. 7 is a graph showing a noise level at a third harmonic band and a fifth harmonic band in a microwave oven to which the magnetron of the present invention is applied, and

FIG. 8 is a graph showing a noise level according to a gap between an A-seal and the choke filter according to the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Reference will now be made in detail to the preferred embodiments of the present invention, examples of which are illustrated in the accompanying drawings.

A magnetron according to the present invention includes a yoke having an inner space formed, for example, by an upper (or first) yoke and a lower (or second) yoke coupled to each other; an upper (or first) magnet and a lower (or second) magnet received (or provided) in the inner space, and fixed to inner surfaces of the upperyoke and the lower yoke in a width direction of the yoke, respectively; an anode cylinder disposed between the upper magnet and the lower magnet for generating a high frequency; an upper (or first) pole piece and a lower (or second) pole piece having a funnel shape, and disposed at upper (first) and lower (Second) openings of the anode cylinder, respectively; a cylindrical A-seal disposed at an upper side (or an upper end) of the upper pole piece, and having a bending portion inwardly bent from an upper end of the A-seal and downwardly extending (i.e., in an axial direction toward a choke filter), for preventing a fifth harmonic from being outwardly leaked; and a vertical choke filter disposed (or provided) at a lower side (e.g., beneath a free end of the bending portion) of the A-seal in a height direction, for preventing a third harmonic from being outwardly leaked.

The vertical choke filter includes a disc portion (e.g., a generally planar disk) having a disc shape having a diameter, a cylinder portion downwardly extending from a lower surface of the disc portion, and a through hole penetratingly formed at the center thereof and having a diameter.

For example, a distance between a lower end (i.e., a free end) of the bending portion and an upper end (e.g., the generally planar disc of the choke filter) of the vertical choke filter is in a range of about 0.5 to about 1.2 mm. In one non-limiting embodiment, the distance (or spacing) therebetween is in a range of about 0.8 mm.

When the distance between a lower end of the bending portion and an upper end of the vertical choke filter is about 0.8 mm, a noise level that a third harmonic and a fifth harmonic are outwardly leaked may be at its lowest.

For example, the through hole may be formed to have a diameter equal to that of the bending portion. Further, a center of a diameter of the through hole and a center of a diameter of the inwardly bent end may be axially aligned However, it should be appreciated that any suitable arrangement for aligning the A-seal and the vertical choke filter may be employed.

Hereinafter, the magnetron according to the present invention will be explained in more detail.

The same reference numerals are given to the same parts as the conventional parts, and thus its detailed explanation will be omitted.

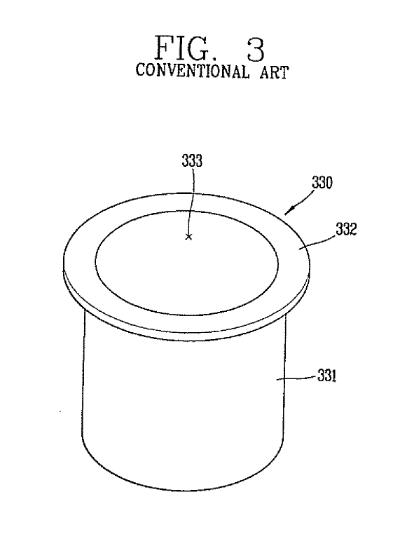

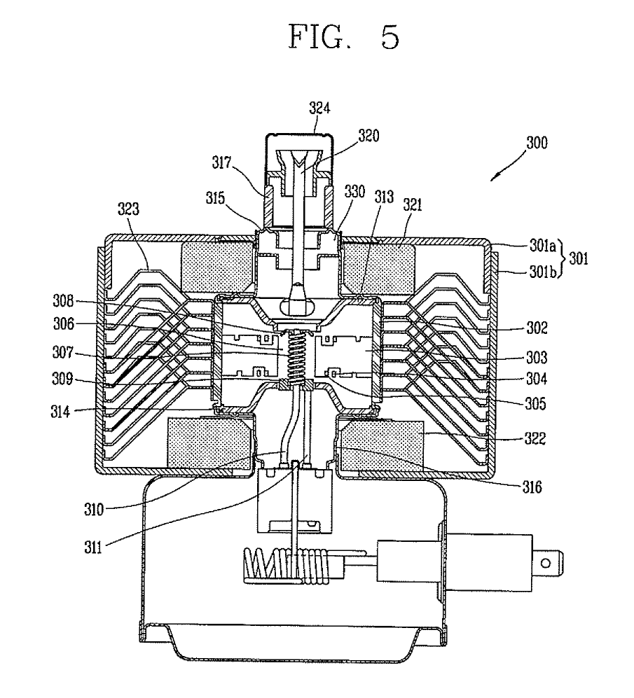

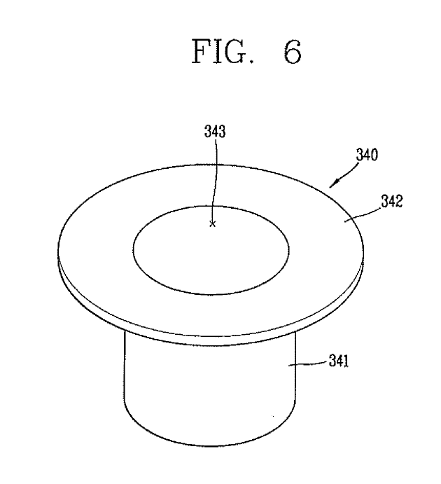

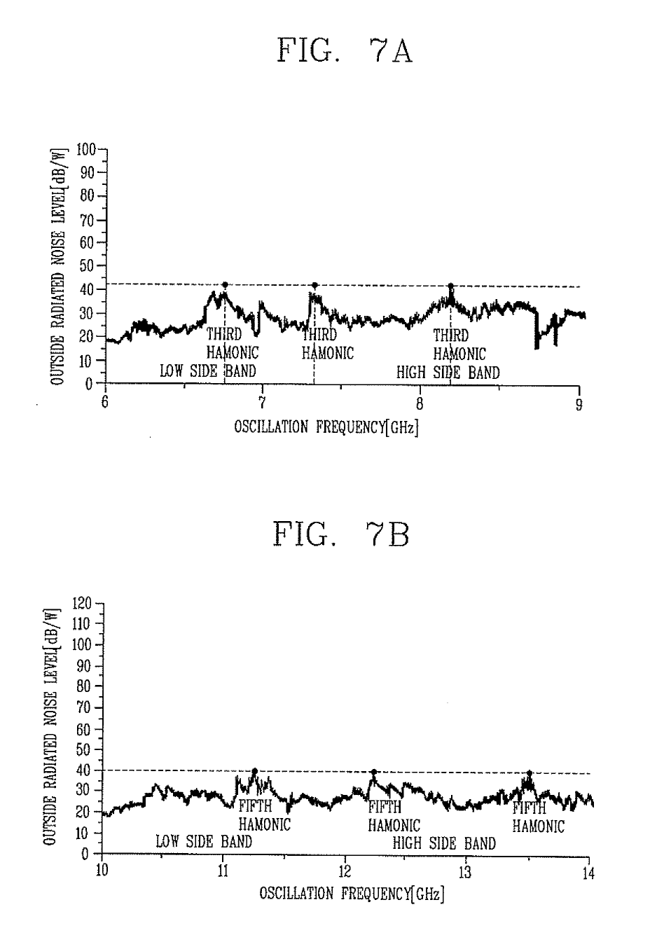

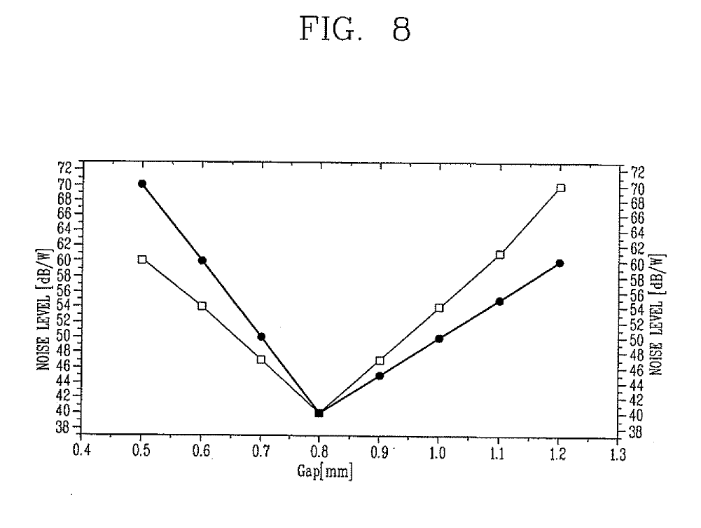

FIG. 5 is a side sectional view showing a magnetron according to a first non-limiting embodiment of the present invention, FIG. 6 is a perspective view showing the choke filter of FIG. 3, FIG. 7 is a graph showing a noise level at a third harmonic band and a fifth harmonic band in a microwave oven to which the magnetron of the present invention is applied, and FIG. 8 is a graph showing a noise level according to a gap (or spacing) between an A-seal and the choke filter according to the present invention.

A magnetron according to the present invention, by way of non-limiting example, may include a yoke 301 having an inner space which may be formed by an upper yoke 301a and a lower yoke 301b coupled to each other. However, it should be appreciated that any suitable arrangement for providing a yoke having an inner space may be employed. Additionally, an upper magnet 321 and a lower magnet 322 received in the inner space, and fixed to inner surfaces of the upper yoke 301a and the lower yoke 301b in a width direction of the yoke 301, respectively; an anode cylinder 302 disposed between the upper magnet 321 and the lower magnet 322 for generating a high frequency; an upper pole piece 313 and a lower pole piece 314 having a funnel shape, and disposed at upper and lower openings of the anode cylinder 302, respectively; a cylindrical A-seal 315 disposed at an upper side of the upper pole piece 313, and having a bending portion inwardly bending from an upper end of the A-seal and downwardly extending, for preventing a fifth harmonic from being outwardly leaked; and a vertical choke filter 340 disposed at a lower side of the A-seal 315 in a height direction, for preventing a third harmonic from being outwardly leaked.

The vertical choke filter 340 may include a disc portion 341 having a disc shape (e.g., a generally planar disc) and a diameter, a cylinder portion 342 downwardly extending from a lower surface of the disc portion 341, and a through hole 343 penetratingly formed at the center thereof and having a certain diameter. For example, a distance between a lower end of the bending portion 315a and an upper end of the vertical choke filter 340 may be in a range of about 0.5 mm to about 1.2 mm. In one non-limiting embodiment, the distance therebetween is in a range of about 0.8 mm.

When the distance between a lower end of the bending portion and an upper end of the vertical choke filter is about 0.8 mm, a noise level having a third harmonic and a fifth harmonic may be outwardly leaked, and may be at its lowest.

The through hole 343 may be formed to have a diameter equal to that of the bending portion 315a so that a closed circuit formed by the A-seal 315 can be equal to a closed circuit formed by the choke filter 340.

As an external power is supplied to the center lead 310 and the side lead 311, a closed circuit of the center lead 310, the filament 307, the top-sealed 308, the end sealed 309, and the side lead 311 is constructed. Accordingly, a current is supplied to the filament 307 thus to heat the filament 307. As the filament 307 is heated, thermo-electron is emitted therefrom and thereby an electron group is formed.

A strong electric field may be generated in the space by a driving voltage supplied to the anode through the side lead 311. As a magnetic flux generated by the upper magnet 321 and the lower magnet 322 is applied to the space along the lower pole piece 314 towards the upper pole piece 313, a strong magnetic field may be generated in the space.

Thermo-electron emitted into the space 306 from a surface of the filament 307 of a high temperature receives force in a vertical direction by the strong electric field inside the space 306. Then, the thermo-electron may be spirally moved to reach the vane 303.

A fifth harmonic of the strong electric field may be filtered by the closed circuit formed by the A-seal 315, thereby preventing outward leakage. Also, a third harmonic of the strong electric field is filtered by the closed circuit formed by the choke filter 340, thereby being prevented from being outwardly leaked.

Thermo-electrons emitted from a surface of the filament 307 of a high temperature into the space 306 receives force in a vertical direction by the strong electric field inside the space 306. Then, the thermo-electron may be spirally moved to reach the vane 303.

The electron group formed by the electron motion causes an interference to the vane 303 with a period corresponding to 1/αn. Herein, the a denotes an oscillation period of a high frequency, and n denotes a multiple. Accordingly, an inductance formed by the space between the vanes 303 and the anode cylinder 302 constitutes a parallel resonance circuit, and a high frequency may be applied to an antenna 320 from the vane 303. Then, the high frequency is emitted outside the magnetron 300 through the antenna 320, thereby driving an electronic device such as a plasma lighting system or a microwave oven.

It is further noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A magnetron, comprising:
a yoke having an inner space provided between first and second ends thereof;
a first magnet and a second magnet provided in the inner space and fixed to the first and second ends, respectively, along a width direction;
an anode cylinder that generates a high frequency provided between the first magnet and the second magnet;
a first pole piece and a second pole piece each having a funnel shape, and provided proximate first and second openings of the anode cylinder, respectively;
a cylindrical A-seal provided proximate an upper end of the first pole piece, and configured to prevent outward leakage of a fifth harmonic, wherein the cylindrical A-seal includes an inwardly bent end extending from an upper end of the A-seal and extending downwardly in an axial direction; and
a choke filter provided beneath a free end of the inwardly bent end of the A-seal, and configured to prevent a third harmonic from being outwardly leaked.

2. The magnetron of claim 1, wherein the choke filter comprises:
a disc having a diameter;
a cylinder having a generally cylindrical shape and extending axially from a lower surface of the disc; and
a through hole having a diameter and penetrating a center of the filter.

3. The magnetron of claim 2, wherein the choke filter is axially spaced from the free end of the inwardly bent end.

4. The magnetron of claim 3, wherein the spacing between the free end of the inwardly bent end and the disk of the choke filter is in a range of about 0.5 mm to about 1.2 mm.

5. The magnetron of claim 2, wherein the through hole is formed to have a diameter equal to that of the inwardly bent end.

6. The magnetron of claim 2, wherein a center of a diameter of the through hole and a center of a diameter of the inwardly bent end are axially aligned.

7. The magnetron of claim 5, wherein a center of the diameter of the through hole and a center of the diameter of the inwardly bent end are axially aligned.

8. The magnetron of claim 1, wherein the choke filter is a vertical choke filter.

9. A magnetron, comprising:
a yoke having an inner space;
a first magnet provided at one end of the inner space;
a second magnet provided at a second end of the inner space, wherein the second magnet is axially spaced from the first magnet;
an anode cylinder that generates a high frequency provided between the first magnet and the second magnet;
a first pole piece and a second pole piece provided proximate first and second openings of the anode cylinder, respectively;
a seal that prevents outward leakage, the seal having an inward protrusion extending axially toward the anode cylinder; and
a choke filter, provided beneath a free end of the inwardly bent end of the seal, that prevents outward harmonic leakage.

10. The magnetron of claim 9, wherein the choke filter comprises:
a generally planar disc having a diameter;
a generally cylindrical end extending axially from a lower surface of the disc, and
a through hole having a diameter and penetrating a center of the filter.

11. The magnetron of claim 10, wherein the choke filter is axially spaced from the free end of the inwardly bent end.

12. The magnetron of claim 11, wherein the spacing between the free end of the inwardly bent end and the disk of the choke filter is in a range of about 0.5 mm to about 1.2 mm.

13. The magnetron of claim 11, wherein the through hole is formed to have a diameter equal to that of the inwardly bent end.

14. The magnetron of claim 11, wherein a center of a diameter of the through hole and a center of a diameter of the inwardly bent end are axially aligned.

15. The magnetron of claim 13, wherein a center of the diameter of the through hole and a center of the diameter of the inwardly bent end are axially aligned.

16. The magnetron of claim 9, wherein the choke filter is a vertical choke filter.

17. The magnetron of claim 9, wherein the seal is a cylindrical A-seal.

18. The magnetron of claim 9, wherein the first and second pole pieces are generally funnel-shaped.

19. The magnetron of claim 18, wherein the seal is configured to prevent outward leakage of a fifth harmonic, and the choke filter is configured to prevent outward leakage of a third harmonic.

20. A magnetron, comprising:
a yoke having an inner space;
a seal that prevents outward leakage provided in the inner space, the seal having an inward protrusion extending axially toward a choke filter; wherein the choke filter is provided beneath a free end of the inwardly bent end of the seal thereby preventing outward leakage of a third harmonic.

21. The magnetron of claim 20, wherein the choke filter is axially spaced from the free end of the inwardly bent end.

22. The magnetron of claim 21, wherein the spacing between the free end of the inwardly bent end and the disk of the choke filter is in a range of about 0.5 mm to about 1.2 mm.
